(19) United States
(12) Patent Application Publication
(10) Pub. No.: US 2021/0148485 A1
(43) Pub. Date: May 20, 2021

(54) PROPORTIONAL VALVE FOR CONTROLLING A GASEOUS MEDIUM

(71) Applicant: Robert Bosch GmbH, Stuttgart (DE)

(72) Inventor: Hans-Christoph Magel, Reutlingen (DE)

(21) Appl. No.: 16/625,750

(22) PCT Filed: Apr. 25, 2018
(86) PCT No.: PCT/EP2018/060528

§ 371 Date: Dec. 22, 2019

(30) Foreign Application Priority Data
Jun. 21, 2017 (DE) 10 2017 210 364.7

(51) Int. Cl. F16K 31/06; F16K 1/42; H01M 8/04089; F16K 1/36

(52) U.S. Cl. CPC F16K 31/0655; F16K 1/36; H01M 8/04089; F16K 1/42

(57) ABSTRACT

The invention relates to a proportional valve (1) for controlling a gaseous medium, in particular hydrogen, comprising a valve housing (2), on which a nozzle body (20) is formed. A closing element (18) is arranged in the valve housing (2), wherein the closing element (18) releases or blocks at least one passage opening (27) formed on the nozzle body (20) on a valve seat (30) formed on the nozzle body (20). Moreover, the closing element (18) is movably guided in a reciprocating manner in an axial guide (16) in the nozzle body (20).

### BACKGROUND OF THE INVENTION

The invention relates to a proportional valve for controlling a gaseous medium, in particular hydrogen, for example for use in vehicles having a fuel cell drive.

In the sphere of vehicle development, gaseous fuels, in particular hydrogen, are an alternative to the conventional liquid fuels. Hydrogen gas flows have to be controlled in vehicles having a fuel cell as the drive, wherein the gas flows are not controlled discontinuously, as when liquid fuel is injected, but rather, for example, use is made of proportional valves which adapt an opening cross section depending on a desired driving power.

DE 10 2012 204 565 A1 describes a proportional valve for controlling a gaseous medium, in particular hydrogen, wherein the proportional valve comprises a nozzle body, a closing element and an elastic sealing element. The nozzle body has at least one through opening which can be opened up or closed on a valve seat by the closing element. The elastic sealing element seals here against the valve seat and has a recess with an inner wall region. In the closed state of the proportional valve, the inner wall region is acted upon by pressure of the gaseous medium.

Proportional valves are distinguished to the effect that, when they are used, only small pressure fluctuations occur in the anode path of a fuel cell and a quiet operation can be ensured. Frequent opening and closing operations occur in the normal operating range of the proportional valve. In order to optimize flushing operations in the anode path of the fuel cell or for the optimized operation of a suction jet pump in a fuel cell arrangement, additional switching operations may also be desired. Frequent opening and closing of the proportional valve leads to wear on the valve seat, in particular if a closing element having an elastic sealing element, as shown in DE 10 2012 204 565 A1, is used.

### SUMMARY OF THE INVENTION

By contrast, the proportional valve according to the invention for controlling a gaseous medium, in particular hydrogen, has the advantage that the tightness of the valve seat is ensured even during frequent opening and closing operations of the proportional valve, and a reduction in the wear of the valve seat is obtained. For this purpose, the proportional valve has a valve housing on which a nozzle body is formed. A closing element is arranged in the valve housing, wherein the closing element opens up or blocks at least one through opening, which is formed on the nozzle body, on a valve seat formed on the nozzle body. According to the invention, the closing element is guided in an axial guide in the nozzle body in a manner which allows it to perform a stroke motion.

In order to improve the tightness of the valve and in order to reduce wear to the valve seat, the closing element is guided, wherein the guide is advantageously formed directly in the component on which the valve seat is formed, namely in the nozzle body. In addition to an optimized manner of operation of the proportional valve, an increase in the service life thereof is thereby obtained.

In a first advantageous development of the inventive concept, it is provided that the valve seat is designed as a flat valve seat. In an advantageous manner, an elastic sealing element which seals against the valve seat is arranged between the closing element and the valve seat. By means of the use of a flat valve seat in combination with an elastic sealing element for sealing against the valve seat, the tightness of the proportional valve can be ensured in a simple manner and without great structural changes, and therefore, for example, no hydrogen is conducted out of the proportional valve in the direction of an anode region of a fuel cell.

In further advantageous embodiments, an inflow space and an outflow space which are interconnectable via the at least one through opening are formed in the valve housing. A gas flow, in particular hydrogen-gas flow, through the proportional valve in the direction of the anode region of the fuel cell can thus be ensured.

In an advantageous development, it is provided that the inflow space is divided by the closing element into a first partial inflow space and a second partial inflow space, wherein the first partial inflow space and the second partial inflow space are interconnected via longitudinal bores formed in the closing element. As a result, a gas flow, in particular hydrogen-gas flow, from the proportional valve in the direction of the anode region of the fuel cell can be obtained when the closing element is open.

In further refinements of the invention, it is advantageously provided that a solenoid is arranged between an internal pole and an external pole in the valve housing, wherein a solenoid armature accommodated in the internal pole and the valve housing is movable by the solenoid so as to perform a stroke motion. In an advantageous manner, the solenoid armature is fixedly connected in a solenoid armature space to a first connecting element, wherein the first connecting element is operatively connected to the closing element. Thus, when the solenoid is activated, the closing element can lift off from the valve seat by means of the solenoid armature and can open up the at least one through opening.

In further advantageous refinements of the inventive concept, the valve housing and the internal pole bound a spring space, in which spring space a first spring is arranged, wherein the first spring is supported at that end of the first connecting element which faces away from the closing element and applies force to the solenoid armature, which is operatively connected to the first connecting element, in the direction of the closing element. The first spring ensures the operative attachment of the first connecting element to the closing element, that is to say the continuous sitting of the first connecting element on the closing element.

In a further refinement of the invention, it is advantageously provided that the spring space is connected to the solenoid armature space via a first channel. Pressure between the spring space and the solenoid armature space can thereby be equalized, and therefore, for example, no further pneumatic forces act on the first connecting element or the solenoid armature and said forces do not influence the stroke of the first connecting element and the solenoid armature.

In an advantageous development of the inventive concept, a through bore is formed in the internal pole, wherein the first connecting element is accommodated and guided in the through bore. A reliable manner of operation of the proportional valve with optimum utilization of the construction space can thus be ensured.

In a further refinement of the invention, it is advantageously provided that the solenoid armature space is connected to the inflow space or to the outflow space via a second channel. This likewise permits the pressure between the solenoid armature space, the inflow space and the outflow space to be equalized, and therefore the stroke of the solenoid armature is not influenced by additional pneumatic forces within the solenoid armature space.

In advantageous embodiments of the invention, a second connecting element is arranged in the outflow space, wherein the second connecting element is operatively connected to the closing element. In an advantageous manner, a second spring is arranged in the outflow space, wherein the second spring is supported on the second connecting element and on the valve housing. Depending on the orientation of the closing element, the second spring therefore supports the tightness of the valve seat or the rapid and effective opening of the closing element, which contributes to an optimum manner of operation of the entire proportional valve.

The described proportional valve is suitable preferably in a fuel cell arrangement for controlling a supply of hydrogen to the anode region of a fuel cell.

### BRIEF DESCRIPTION OF THE DRAWINGS

The drawing illustrates exemplary embodiments of a proportional valve according to the invention for controlling a supply of gas, in particular hydrogen, to a fuel cell. In the drawing

FIG. 1 shows a first exemplary embodiment of a proportional valve according to the invention with a guided closing element in longitudinal section,

FIG. 2 shows a second exemplary embodiment of the proportional valve according to the invention with the guided closing element in longitudinal section,

FIG. 3 shows a third exemplary embodiment of the proportional valve according to the invention with the guided closing element in longitudinal section,

FIG. 4 shows a possible embodiment of a fuel cell arrangement with the proportional valve according to the invention from FIG. 1, FIG. 2 or FIG. 3 in a schematic illustration.

### DETAILED DESCRIPTION

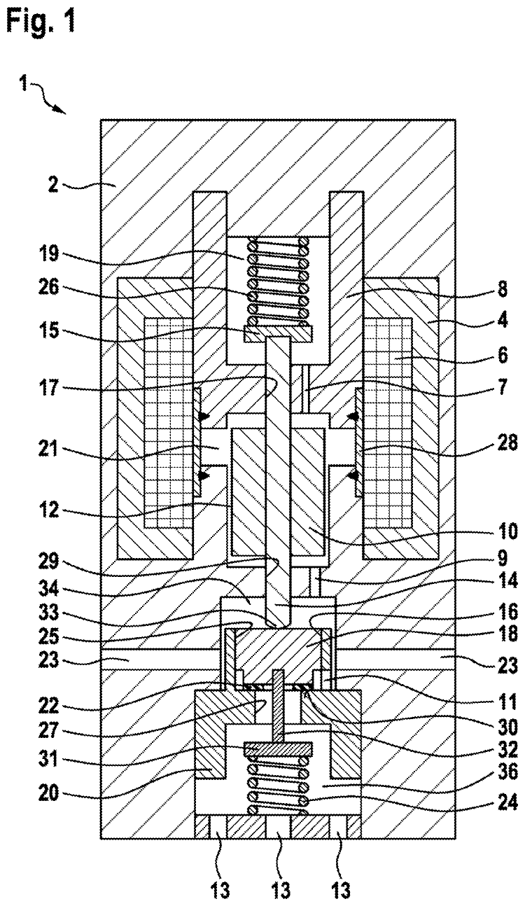

FIG. 1 shows a first exemplary embodiment of a proportional valve 1 according to the invention in longitudinal section. The proportional valve 1 has a valve housing 2 in which an external pole 4, an internal pole 8, a solenoid 6 and a nozzle body 20 are arranged. The internal pole 8 contains a first through bore 17 through which a first connecting element 14 projects, wherein the first connecting element 14 is guided axially in the first through bore 17. The first connecting element 14 is fixedly connected to a solenoid armature 10, wherein a solenoid air gap 12 is formed between the solenoid armature 10 and the valve housing 2.

The internal pole 8 and the valve housing 2 bound a spring space 19 in which a first spring 26 is arranged. This first spring 26 is supported firstly on the valve housing 2 and secondly on the plate-like end 15 of the first connecting element 14 and applies a force thereto in the direction of the nozzle body 20. In addition, the internal pole 8 and the valve housing 12 bound a solenoid armature space 21 in which the solenoid armature 10 which is fixedly connected to the connecting element 14 is arranged. The spring space 19 and the solenoid armature space 21 are interconnected via a first channel 7. The valve housing 2 and the internal pole 8 are interconnected via a spacer bushing element 28 which is produced from a non-magnetic material.

The nozzle body 20 is fixedly connected to the valve body 2, wherein the nozzle body 20 has a through opening 27. In a recess 25 of the nozzle body 20, a closing element 18 with an elastic sealing element 22 is guided in an axial guide 16. The nozzle body 20 has a flat valve seat 30 which interacts with the elastic sealing element 22 of the closing element 18 such that, when the closing element 18 rests with the elastic sealing element 22 on the flat valve seat 30, the through opening 27 is closed.

When the through opening 27 is closed, the valve body 2 and the nozzle body 20 bound an inflow space 34, into which gas, for example hydrogen, can flow through inlet openings 23 formed in the valve body 2. Via a supply opening 11, the gas passes as far as the flat valve seat 30. The inflow space 34 is connected to the solenoid armature space 21 via a second channel 9. The first connecting element 14 projects into the inflow space 34 from the solenoid armature space 21 via a second through bore 29 formed in the valve body 2, and is guided axially on the second through bore 29. Furthermore, because of the spring force of the first spring 26, the first connecting element 14 sits with its end 33 facing the closing element 18 on the closing element 18 and is operatively connected thereto. The end 33 of the first connecting element 14 is of spherical design in order to better compensate for angular tolerances.

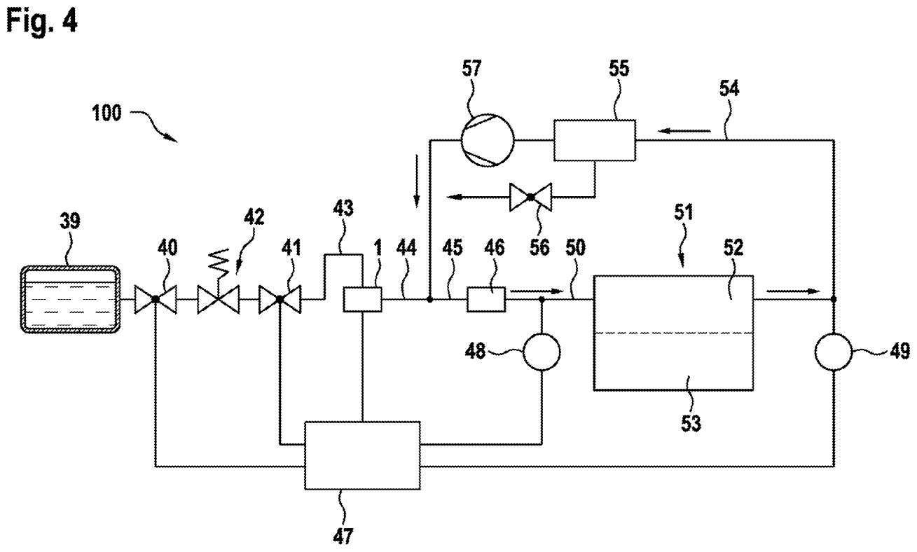

The nozzle body 20 and the valve body 2 furthermore bound an outflow space 36 in which a second connecting element 32 and a second spring 24 are arranged. The second connecting element 32 is fixedly connected at one end to the closing element 18, wherein the second spring 24 is supported firstly on the valve body 2 and secondly on the plate-like end 31 of the second connecting element 32 and exerts a force on the second connecting element 32 in the direction of the closing element 18. In the valve body 2, outlet openings 13 are arranged in the region of the outflow space 36, through which outlet openings the gas can flow out of the outflow space 36 and therefore out of the proportional valve 1, for example, into an inflow region 44 of a jet pump 46 (see FIG. 4).

Manner of Operation of the Proportional Valve 1 in the First Exemplary Embodiment

If the solenoid 6 is not energized, force is applied to the closing element 18 by the first connecting element 14, which lies against the closing element 18, in the direction of the outlet openings 13 by the first spring 26 such that the closing element 18 lies with the elastic sealing element 22 against the flat valve seat 30. Via the second connecting element 32, force is applied to the closing element 18 in the direction of the solenoid armature 10 by the second spring 24 in order, when the solenoid 6 is switched on, to accelerate the operation of lifting the closing element 18 off from the flat valve seat 30. The first spring 26 and the second spring 24 therefore act in opposite directions on the closing element 18, wherein the first spring 26 has a greater spring force than the second spring 24 in order to ensure the tightness of the valve seat 30.

If the solenoid 6 is energized, a magnetic force which is directed counter to the spring force of the first spring 26 is produced on the solenoid armature 10. As a result, the solenoid armature 10 moves in the direction of the first spring 26, and therefore the force applied to the closing element 18 by the first connecting element 14, which is fixedly connected to the solenoid armature 10, is reduced. The elastic sealing element 22 follows the movement of the first connecting element 14 and lifts off from the sealing seat 30. The through opening 27 is now opened up, and therefore the gas can flow out of the inflow space 34 via the supply opening 11, the outflow space 36 and the outlet openings 13 into the inflow region 44 of the jet pump 46 (see FIG. 4).

If the current strength at the solenoid 6 is increased, this leads to a greater opening stroke of the closing element 18 since the force of the first spring 26 is dependent on the stroke. When the current strength is reduced, the opening stroke of the closing element 18 is reduced. Therefore, by varying the current strength at the solenoid 6, the gas flow in the proportional valve 1 can be controlled and can be adapted and optimized depending on requirements, for example when metering hydrogen into a fuel cell 51 (see FIG. 4).

When the energizing of the solenoid 6 is ended, the magnetic force dissipates, and therefore the spring force of the first spring 26 now predominates again and the closing element 18 is thereby moved in the direction of the valve seat 30 by means of the first connecting element 14 in conjunction with the solenoid armature 10 and the elastic sealing element 22 again seals against the valve seat 30. The gas flow in the proportional valve 1 is therefore interrupted. By means of the axial guide 16 of the closing element 18 in the nozzle body 20, radial movements of the closing element 18 are suppressed, and therefore the closing element 18 always takes up the same position on the valve seat 30 and unnecessary wear is thus avoided.

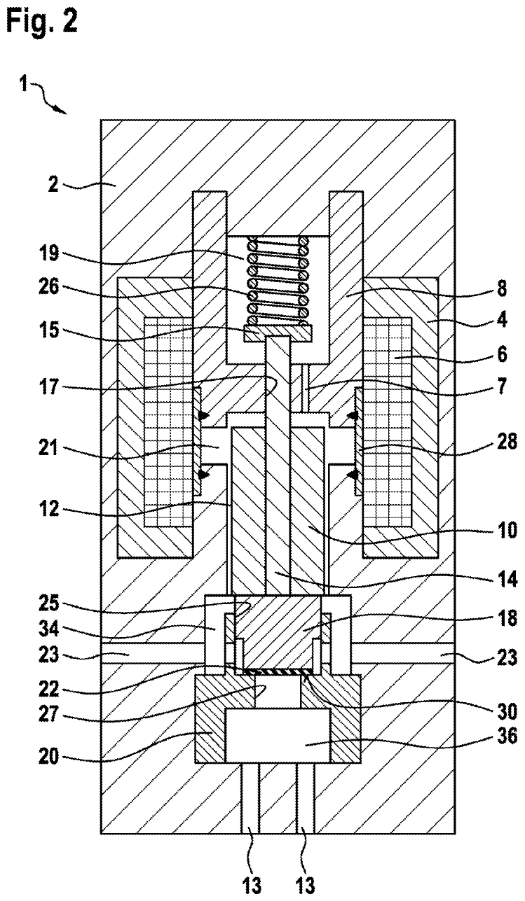

FIG. 2 shows a second exemplary embodiment of the proportional valve 1 according to the invention in longitudinal section. Components having an identical function have been denoted by the same reference numbers as in FIG. 1. In contrast to the exemplary embodiment in FIG. 1, the first connecting element 14, the solenoid armature 10 and the closing element 18 are fixedly interconnected as one component. In this case, the second connecting element 32 and the second spring 24 can be omitted.

Furthermore, the first connecting element 14 is accommodated and axially guided only at the first through bore 17. The second channel 9 in the valve housing 2 is omitted. The second through bore 29 is omitted. The basic construction and the manner of operation of the second exemplary embodiment correspond to that of the first. As in the first exemplary embodiment, the closing element 18 is accommodated and guided in the recess 25 of the nozzle body 20.

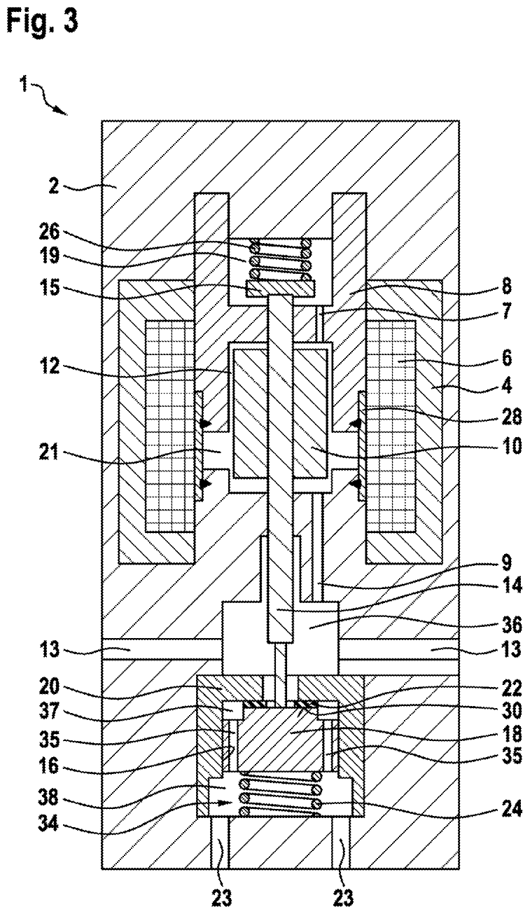

FIG. 3 shows a third exemplary embodiment of the proportional valve 1 according to the invention in longitudinal section. Components having an identical function have been denoted by the same reference numbers as in FIG. 1. In contrast to the exemplary embodiment in FIG. 1, the gas flow through the proportional valve 1 is reversed here, and therefore the outflow space 36 here corresponds to the inflow space 34, and vice versa. The same applies to the inlet openings 23 and the outlet openings 13. In addition, the second connecting element 32 is omitted in the second exemplary embodiment, with the second spring 24 now being supported directly on the closing element 18. The closing element 18 is also arranged here in the inflow space 34 and is guided in an axial guide 16 of the nozzle body 20. The closing element 18 with the elastic sealing element 22 is pressed here against the flat valve seat 30 via the second spring 24. Furthermore, the closing element 18 has bores 35, here longitudinal bores, through which, when the valve seat 30 is open, gas can flow in the direction of the outlet openings 13. The inflow space 34 is divided by the closing element 18 into a first partial inflow space 37 and a second partial inflow space 38 which are interconnected via the bores 35.

Manner of Operation of the Proportional Valve 1 in the Second Exemplary Embodiment

If the solenoid 6 is not energized, the closing element 18 is pressed against the valve seat 30 via the second spring 24, and therefore the connection between the inflow space 34 and the outflow space 36 is interrupted and gas does not flow through them. The first spring 26 acts counter to the spring force of the second spring 24 and presses the first connecting element 14 onto the closing element 18. The spring force of the second spring 24 is greater than the spring force of the first spring 26 in order to ensure the tightness of the closing element 18 on the valve seat 30.

If the solenoid 6 is energized, a magnetic force is applied to the solenoid armature 10 in the direction of the closing element 18. Said magnetic force is transmitted to the closing element 18 via the first connecting element 14, and therefore the second spring 24 is overcompensated with the aid of the spring force of the first spring 26 and lifts off the closing element 18 from the valve seat 30 and said closing element moves in the direction of the inlet openings 23. A gas flow from the inflow space 34 of the proportional valve 1 via the longitudinal bores 35, the through opening 27, the outflow space 36 and the outlet openings 13, for example, into the inflow region 44 of the jet pump 46 (see FIG. 4) is opened up.

As in the first exemplary embodiment, the stroke of the closing element 18 can be set via the level of current strength at the solenoid 6. The greater the current strength at the solenoid 6, the greater is the stroke of the closing element 18 and also the greater is the gas flow in the proportional valve 1, since the force of the first spring 26 is dependent on the stroke. If the current strength at the solenoid 6 is reduced, the stroke of the closing element 18 is also reduced and therefore the gas flow throttled.

If the current at the solenoid 6 is interrupted, the magnetic force on the solenoid armature 10 is dissipated, and therefore the latter moves again in the direction of the first spring 26 and the force applied to the closing element 18 by means of the first connecting element 14 is reduced. The closing element 18 follows the movement of the first connecting element 14 and seals with the elastic sealing element 22 against the valve seat 30. The gas flow in the proportional valve 1 is interrupted, and therefore, for example, no more gas can flow out of the proportional valve 1 into the inflow region 44 of the jet pump 46 (see FIG. 4).

Also in the second exemplary embodiment of the proportional valve 1, the closing element 18 is guided via the axial guide 16 in the nozzle body 20 in order to avoid radial misalignments of the closing element 18.

FIG. 4 shows a possible embodiment of a fuel cell arrangement 100 with the proportional valve 1 according to the invention and with the jet pump 46, which is connected to the fuel cell 51 via a connecting line 50. The fuel cell 51 comprises an anode region 52 and a cathode region 53. In addition, a return line 54 is provided which connects the anode region 52 of the fuel cell 51 to the intake region 45 of the jet pump 46. By means of the return line 54, a first gaseous medium, which is substantially a mixture of hydrogen, nitrogen and water vapor, which arises in the anode region 51 during the operation of the fuel cell 51 is returned to the intake region 45. A water separator 55 with a shut-off valve 56 is provided in the return line 54 in order to be able to release the first gaseous medium located in the return line 54, optionally to the outside. A recirculation pump 57 arranged in the return line 54 downstream of the water separator 55 guides the hydrogen not used in the fuel cell 51 back again into the intake region 45 of the jet pump 46.

A first pressure sensor 48 for sensing the pressure in the connecting line 50 is provided in the connecting line 50. Furthermore, a second pressure sensor 49 for sensing the pressure in the return line 54 is provided in the return line 54. The sensed pressure values are supplied to a control unit 47, which is connected to the proportional valve 1, for controlling the pressure in the anode region 52 of the fuel cell 51. The control unit 47 controls the level of the current strength at the solenoid 6 of the proportional valve 1, by means of which the stroke of the closing element 18 is actuated so that a flow cross section of the through opening 27 is changed in such a manner that the gas flow supplied to the fuel cell 51 is set continuously to meet requirements.

A second gaseous medium stored in the tank 39, here hydrogen, is supplied to the inflow region 44 of the jet pump 46 via the proportional valve 1. The inflow line 43 is provided with a pressure-regulating valve 42 which is connected to the control unit 20 in order to set a pressure at the inflow region 44 of the jet pump 46. In addition, a first shut-off valve 40 is arranged between the pressure-regulating valve 42 and the tank 39 and a second shut-off valve 41 is arranged between the pressure-regulating valve 42 and the proportional valve 1. The shut-off valves 40, 41 are likewise connected to the control unit 47 in order optionally to interrupt the inflow of the second gaseous medium from the tank 39 to the pressure-regulating valve or the inflow on to the proportional valve 1.

The proportional valve 1 for controlling a gaseous medium therefore has the advantage that the supply of the first gaseous medium and the metering in of the second gaseous medium into the anode region 52 of the fuel cell 51 can take place substantially more precisely by means of the electronically controlled adaptation of the flow cross section of the through opening 27 with simultaneous regulation of the anode pressure. By this means, the operating reliability and durability of the connected fuel cell are significantly improved since hydrogen is always supplied in an amount leaner than stoichiometric. In addition, consequential damages, such as, for example, damages to a downstream catalytic converter, can also be prevented.

1. A proportional valve (1) for controlling a gaseous medium, the proportional valve comprising a valve housing (2) on which a nozzle body (20) is formed, wherein at least one through opening (27) is formed in the nozzle body (20) and a valve seat (30) is formed on the nozzle body (20), wherein a closing element (18) is arranged in the valve housing (2), and wherein the closing element (18) opens up or blocks the at least one through opening (27) by moving away or toward the valve seat (30), characterized in that the closing element (18) is guided in an axial guide (16) in the nozzle body (20) in a manner which allows the closing element to perform a stroke movement.

2. The proportional valve (1) for controlling a gaseous medium as claimed in claim 1, characterized in that the valve seat (30) is configured as a flat valve seat (30).

3. The proportional valve (1) for controlling a gaseous medium as claimed in claim 2, characterized in that an elastic sealing element (22) which seals against the valve seat (30) is arranged between the closing element (18) and the valve seat (30).

4. The proportional valve (1) for controlling a gaseous medium as claimed in claim 1, characterized in that an inflow space (34) and an outflow space (36) which are interconnectable via the at least one through opening (27) are formed in the valve housing (2).

5. The proportional valve (1) for controlling a gaseous medium as claimed in claim 4, characterized in that the inflow space (34) is divided by the closing element (18) into a first partial inflow space (37) and a second partial inflow space (38), wherein the first partial inflow space (37) and the second partial inflow space (38) are interconnected via bores (35) formed in the closing element (18).

6. The proportional valve (1) for controlling a gaseous medium as claimed in claim 1, characterized in that a solenoid (6) is arranged between an internal pole (8) and an external pole (4) in the valve housing (2), wherein a solenoid armature (10) accommodated in the internal pole (8) and the valve housing (2) is configured to be moved by the solenoid (6) so as to perform a stroke motion.

7. The proportional valve (1) for controlling a gaseous medium as claimed in claim 6, characterized in that the solenoid armature (10) is fixedly connected in a solenoid armature space (21) to a first connecting element (14), wherein the first connecting element (14) is operatively connected to the closing element (18).

8. The proportional valve (1) for controlling a gaseous medium as claimed in claim 7, characterized in that the valve housing (2) and the internal pole (8) bound a spring space (19), in which a first spring (26) is arranged, wherein the first spring (26) is supported at an end of the first connecting element (14) that faces away from the closing element (18) and applies force to the solenoid armature (10), which is operatively connected to the first connecting element (14), in a direction of the closing element (18).

9. The proportional valve (1) for controlling a gaseous medium as claimed in claim 8, characterized in that the spring space (19) is connected to the solenoid armature space (21) via a first channel (7).

10. The proportional valve (1) for controlling a gaseous medium as claimed in claim 7, characterized in that a first through bore (17) is formed in the internal pole (8), wherein the first connecting element (14) is accommodated and guided in the first through bore (17).

11. The proportional valve (1) for controlling a gaseous medium as claimed in claim 7, characterized in that the solenoid armature space (21) is connected to the inflow space (34) or to the outflow space (36) via a second channel (9).

12. The proportional valve (1) for controlling a gaseous medium as claimed in claim 4, characterized in that a second connecting element (32) is arranged in the outflow space (36), wherein the second connecting element (32) is operatively connected to the closing element (18).

13. The proportional valve (1) for controlling a gaseous medium as claimed in claim 12, characterized in that a second spring (24) is arranged in the outflow space (36), wherein the second spring (24) is supported on the second connecting element (32) and on the valve housing (2).

14. A fuel cell arrangement (100) comprising a fuel cell and a proportional valve (1) as claimed in claim 1, wherein the proportional valve controls a supply of hydrogen to the fuel cell.
